(19) United States
(12) Patent Application Publication
(10) Pub. No.: US 2026/0164103 A1
(43) Pub. Date: Jun. 11, 2026

(54) System and Method for Organism Capture and Recognition Using Hybrid Wireless Mesh Network and LED Spectrum Control

(71) Applicant: XinXin Shan, Surrey (CA)

(72) Inventor: XinXin Shan, Surrey (CA)

(73) Assignee: LED Smart Inc, Surrey (CA)

(21) Appl. No.: 18/977,756

(22) Filed: Dec. 11, 2024

(51) Int. Cl. H04N 23/11; G06V 10/774; G06V 20/69; H04N 23/56; H04W 4/80; H04W 84/18

(52) U.S. Cl. CPC H04N 23/11; G06V 10/774; G06V 20/693; G06V 20/698; H04N 23/56; H04W 4/80; H04W 84/18

(57) ABSTRACT

A system and method for organism capture and recognition using hybrid wireless mesh networks and tunable LED spectrum control. The system employs nodes with tunable LEDs, sensors, and AI processors to attract, repel, or identify organisms in real time. The hybrid wireless mesh network ensures scalable communication, while AI optimizes light emissions and actions. Applications include agriculture, healthcare, and pest control.

### CROSS-REFERENCE TO RELATED APPLICATIONS

### U.S. Patent Documents

20190133105 A1 May 2019 Leach et al.
U.S. Pat. No. 10,152,035 B2 December 2018 Reid et al.
20210056081 A1 February 2021 NATION et al.
U.S. Pat. No. 10,827,738 B2 November 2020 Kim et al.
20190331701A1 October 2019 POLLEY et al.

### Other Publication

KR102691773B1 December 2020 Kim et al.

### BACKGROUND OF THE INVENTION

Current methods for organism capture and monitoring are often constrained by limited functionality, scalability, and adaptability to changing environments. Many rely on fixed, standalone devices that fail to provide real-time, dynamic responses to different organisms or environmental conditions.

Advances in hybrid wireless communication and tunable LED technology offer new opportunities for addressing these limitations, providing scalable and efficient systems for monitoring and controlling organisms.

This invention combines these technologies into a robust, scalable, and flexible system for organism capture and recognition, enabling significant improvements in efficiency, adaptability, and automation.

### SUMMARY OF THE INVENTION

The invention provides a system and method comprising:

Tunable LED Arrays: Capable of emitting a customizable range of light wavelengths (UV, visible, and IR) for attracting, repelling, or identifying organisms.

Hybrid Wireless Mesh Network: Combines Thread, Wi-Fi, Bluetooth and Bluetooth mesh protocols for efficient communication and scalability.

Sensors: Include environmental sensors (temperature, humidity, CO₂) and imaging sensors (high-resolution cameras) for organism detection and data collection.

AI-Enabled Processors: Use real-time machine learning models for organism recognition, spectrum optimization, and decision-making.

Blockchain Security: Ensures secure data transmission and storage.

User Interfaces: Web and mobile platforms allow for system monitoring, data visualization, and control.

This invention addresses the shortcomings of existing systems by providing dynamic and real-time organism monitoring and control in diverse environments.

### BRIEF DESCRIPTION OF DRAWINGS

FIG. 1 System Overview: Diagram showing relationships between nodes, servers, and interfaces.

FIG. 2 Node Architecture: Details of LED arrays, sensors, processors, and communication modules.

FIG. 3 Workflow: Flowchart illustrating the steps for organism capture and recognition.

FIG. 4 Spectrum Control: Graph showing tunable LED wavelength ranges and organism responses.

FIG. 5 Network Communication: Diagram of hybrid wireless mesh network interactions.

### DETAILED DESCRIPTION OF THE INVENTION

The present invention relates to a system that integrates various components to optimize light emission, organism capture, and network communication.

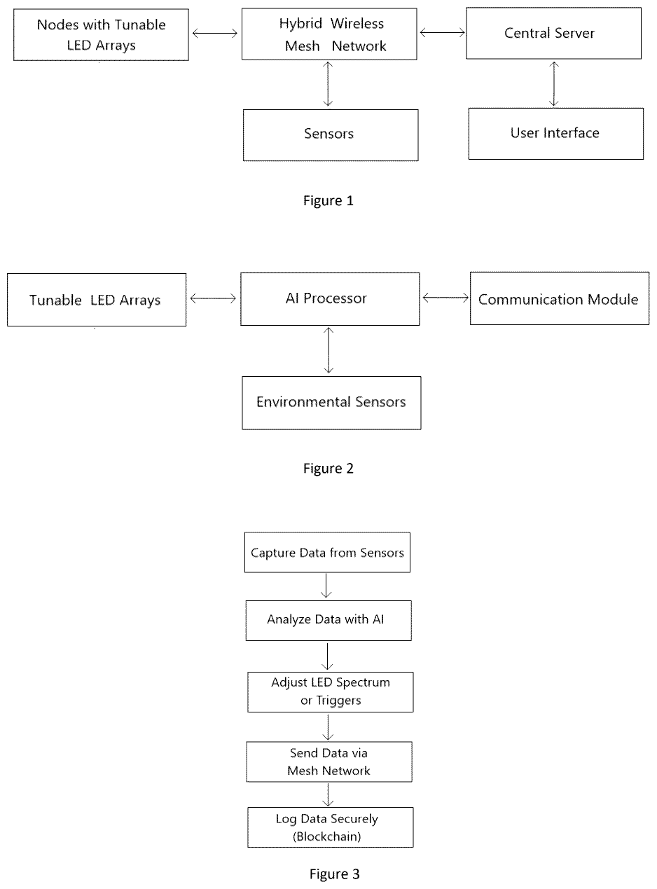

FIG. 1 illustrates the system overview, showing the relationships between nodes, servers, and interfaces. The system comprises multiple components, each playing a vital role in the overall functionality and efficiency.

The system includes tunable LED arrays that emit light spectrums across ultraviolet (UV), visible, and infrared (IR) ranges to influence target organisms. The wavelength ranges for the ultraviolet light include UV-A (315-400 nm), which attracts moths, mosquitoes, and other insects; UV-B (280-315 nm), which induces biological responses in some organisms; and UV-C (200-280 nm), primarily used for sterilization and repelling pests. The visible light includes blue (450-495 nm), which attracts thrips and whiteflies and enhances phototropic responses; green (495-570 nm), which provides a neutral stimulus for monitoring; yellow (570-590 nm), which attracts aphids and fungus gnats; and red (620-750 nm), which optimizes plant health monitoring and repels specific pests. The infrared light includes near-infrared (750-1000 nm), which enhances organism detection using thermal imaging, and far-infrared (>1000 nm), which aids environmental sensing.

FIG. 2 details the node architecture, which includes LED arrays, sensors, processors, and communication modules. This architecture ensures the efficient and effective operation of the system components.

The system employs a hybrid wireless mesh network, as shown in FIG. 5, that integrates Thread, Wi-Fi, Bluetooth and Bluetooth mesh protocols to provide robust and scalable communication. The network adapts dynamically to optimize performance based on real-time conditions.

Environmental sensors, depicted in FIG. 2, monitor temperature, humidity, and CO₂ levels, while imaging sensors capture high-resolution images of organisms for recognition. AI-enabled processors execute real-time organism recognition using deep learning models and optimize the LED spectrum and environmental parameters dynamically.

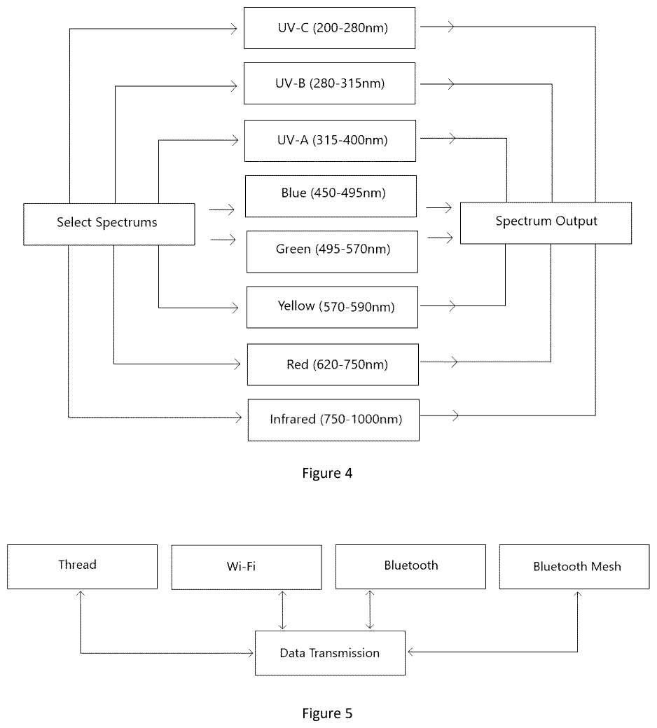

FIG. 4 presents spectrum control, showing a graph of tunable LED wavelength ranges and organism responses. The ability to adjust the light spectrum is crucial for effectively attracting, repelling, or identifying organisms.

Data security is ensured through blockchain technology, which provides secure and tamper-proof data storage and transmission. User interfaces, available on web and mobile platforms, offer real-time monitoring, visualization, and control capabilities, enhancing user interaction with the system.

The methodology of the invention includes steps for organism capture and recognition, as illustrated in FIG. 3. The workflow flowchart shows the steps involved in this process, from the emission of specific wavelengths by the tunable LED arrays to the capture of data by sensors. The sensors capture high-resolution images and environmental parameters.

AI algorithms then process the sensor data for organism classification and decision-making. Based on the AI analysis, the system triggers actions such as adjusting LED spectrums, activating traps, or sending alerts.

Network communication is facilitated through a hybrid wireless mesh network, where nodes communicate dynamically by selecting the optimal protocol for efficiency. This process is depicted in FIG. 5, illustrating the interactions within the network.

Data security and logging are maintained using blockchain technology, which ensures secure data handling and logs actions for compliance and optimization.

1. A system comprising:
At least one node including tunable LED arrays for emitting customizable light spectrums to attract or repel organisms;
Sensors for capturing environmental and organism data;
A hybrid wireless mesh network supporting Thread, Wi-Fi, Bluetooth and Bluetooth mesh protocols;
A processor for transmitting data to a central server and receiving commands to control node functions.

2. The system of claim 1, wherein the tunable LED arrays emit UV light in the range of 200-400 nm for organism attraction or repulsion.

3. The system of claim 1, wherein the sensors include high-resolution cameras for organism detection and classification.

4. The system of claim 1, wherein the hybrid wireless mesh network dynamically selects communication protocols to optimize energy efficiency.

5. The system of claim 1, further comprising:
AI-enabled processors for real-time recognition and classification of organisms;
AI algorithms for optimizing LED spectrum emissions based on sensor data.

6. The system of claim 5, wherein AI processors use machine learning models trained on organism datasets to improve recognition accuracy.

7. The system of claim 5, wherein the AI dynamically adjusts light wavelength emissions based on environmental changes.

8. A method for organism capture and recognition, comprising:
Emitting tunable LED spectrums to influence target organisms;
Collecting environmental and organism-specific data using sensors;
Using hybrid wireless communication for real-time data transfer;
Triggering actions, including traps, repellents, or environmental adjustments.

9. The method of claim 8, wherein blockchain technology ensures secure data transmission between nodes.

10. The method of claim 8, wherein actions triggered include sending real-time alerts to user interfaces.
